(19) United States
(12) Patent Application Publication
(10) Pub. No.: US 2026/0103087 A1
(43) Pub. Date: Apr. 16, 2026

(54) MULTI-PHASE ELECTRIC DRIVE WITH VARIABLE POWER CONNECTION

(71) Applicant: Dr. Ing. h.c. F. Porsche Aktiengesellschaft, Stuttgart (DE)

(72) Inventors: Maximilian CLAUER, Weissach (DE); Wolfgang Maximilian BLASCHKE, Weissach-Flacht (DE); Jens HOFFMANN, Aachen (DE)

(21) Appl. No.: 19/342,768

(22) Filed: Sep. 29, 2025

(30) Foreign Application Priority Data
Oct. 14, 2024 (DE) 10 2024 129 603.8

(51) Int. Cl. B60L 15/20; B60L 15/00

(52) U.S. Cl. CPC B60L 15/20; B60L 15/007; B60L 2240/52

(57) ABSTRACT

A drive system for an electric vehicle includes a first electric machine, which is coupled to a first axle of the electric vehicle; and at least one second electric machine, which is coupled to a second axle of the electric vehicle. The first electric machine is permanently connected to a first number of first inverters, and the at least one second electric machine is permanently connected to a second number of second inverters. A further inverter is provided, which is optionally connectable to the first electric machine or to the at least one second electric machine via a switching device.

### CROSS REFERENCE TO RELATED APPLICATIONS

This application claims benefit to German Patent Application No. DE 10 2024 129 603.8, filed on Oct. 14, 2024, which is hereby incorporated by reference herein.

### FIELD

The present invention relates to multi-phase electric drive with variable power connection.

### BACKGROUND

A goal in developing a powertrain for high-performance vehicles is to have a high torque associated with a high maximum speed. This allows for both a high acceleration of the vehicle and a high top speed and applies equally to vehicles with an internal combustion engine as well as an electric motor. To provide dynamic cornering, some electric vehicle manufacturers have relied on single-wheel drives to achieve optimum torque distribution during cornering through torque vectoring (torque distribution). In order to achieve better driving dynamics in vehicles with electric drive during cornering, either electromechanical torque vectoring with active differential or a single wheel drive with two separately controllable electric drives are currently used.

Document EP 3 474 434 A1 discloses an electric drive system for a motor vehicle comprising at least two and preferably three electric machines, wherein each of the electric machines is supplied with AC power via a separate inverter associated with it. At least one inverter with silicon semiconductor components and at least one inverter with silicon carbide semiconductor components are provided. In one embodiment, one electric machine drives a front axle of the motor vehicle and another electric machine drives a rear axle of the motor vehicle. Alternatively, each wheel of the motor vehicle may be driven by its own electric machine.

Publication DE 10 2010 015 424 B4 discloses a drive device for a four-wheel driven vehicle having a front axle drive, a rear axle drive, and a control device that determines a drive torque to drive the vehicle based on a driver request. According to the publication, the control device is associated with a torque distribution unit that divides the drive torque into an axle torque for the front axle drive and into an axle torque for the rear axle drive. With the two axle wheel torques, the front axle drive and the rear axle drive are independently controllable.

Publication DE 10 2023 118 327 A1 discloses a powertrain system having a first drive machine for supplying torque to a front axle, a second drive machine for supplying torque to a rear axle, and a controller configured to command the front axle and the rear axle to successively cross backlash zones in response to a torque reversal.

### SUMMARY

In an embodiment, the present disclosure provides a drive system for an electric vehicle, including a first electric machine, which is coupled to a first axle of the electric vehicle; and at least one second electric machine, which is coupled to a second axle of the electric vehicle. The first electric machine is permanently connected to a first number of first inverters, and the at least one second electric machine is permanently connected to a second number of second inverters. A further inverter is provided, which is optionally connectable to the first electric machine or to the at least one second electric machine via a switching device.

### BRIEF DESCRIPTION OF THE DRAWINGS

FIG. 1 shows an example embodiment of a powertrain;

FIG. 2 illustrates the interplay of the inverters with the electric machines within the exemplary powertrain shown in FIG. 1; and

FIG. 3 illustrates the exemplary electrical contacting within the first electric machine in the powertrain.

### DETAILED DESCRIPTION

Embodiments of the present invention provide a powertrain for an electric vehicle that combines a demand-based torque distribution during cornering and straight-line travel with a minimum system mass.

Embodiments of the present invention solve technical problems by means of an inverter that can be switched on as desired and can therefore in principle be used by each of the drive axles. The switchable inverter is not permanently connected to a particular electric machine via corresponding power lines, but can control or boost one of the plurality of electric machines by means of a switching device depending on the dynamic state of the electric vehicle.

The drive topology embodiments disclosed herein result in a lower system mass because the DC current of the traction battery may be advantageously actively distributed according to the driving dynamic requirements of the respective driving situation. The dynamically switchable inverter with regard to the drive axes reduces the demands on the inverters in the drive system. In other words, the maximum current does not have to be permanently maintained in the form of inverters with high maximum current values and thus increased inverter mass and inverter power loss, as the current flow through an electric machine, in particular embodiments a permanently excited synchronous machine, can be temporarily increased as needed by connecting the additional inverter.

The high proportion of equal parts in the inverters and the active part geometry of the electric machines leads to a high number of units and thus reduced costs in the development and manufacture of the drive components.

With low dynamic requirements, such as in the WLTP travel cycle, the electric machines can each be operated with only one inverter at a time, thereby reducing system losses due to reduced line and switching losses. In such a case, the switchable inverter is deactivated and is not used to energize one of the electric machines of the powertrain according to embodiments of the invention.

According to various embodiments of the invention, a drive system for an electric vehicle is provided with a first electric machine which is coupled to a first axle of the electric vehicle and at least one second electric machine which is coupled to a second axle of the electric vehicle. The coupling of one of the electric machines with the respective axle is understood to mean a drive-effective coupling, e.g., by means of a gearbox, so that a drive torque can be transmitted from the electric motor to the corresponding axle. A transmission is not mandatory for this purpose, but the electric machine may also be directly connected to the output shaft (direct drive). The drive system according to embodiments of the invention is configured such that the first electric machine is permanently connected to a first number of first inverters and the at least one second electric machine is permanently connected to a second number of second inverters. A further inverter is provided, which can also be referred to as a central inverter of the powertrain according to embodiments of the invention, which is optionally connectable to the first electric machine or to the at least one second electric machines by means of a switching device.

As mentioned above, the further or additional inverter is connected to the first or at least one second electric machine, depending on the driving dynamics situation. By connecting the further inverter to a corresponding parallel winding of an electric machine, it is no longer “idle” but is energized and contributes to torque generation. If necessary, the further inverter may also be deactivated and not participate in generating the drive torque by the powertrain, thereby increasing the range of the electric vehicle.

The number of inverters to which each of the electric machines is permanently connected is based on the number of parallel windings provided in each of the electric machines. Advantageously, each of the electric machines may be permanently (fixed) connected to a number of inverters corresponding to the number of parallel windings minus one. If an electric machine is embodied with a 2×3 phase winding (i.e., two parallel three-phase winding strands), for example, it can be permanently connected to an inverter. However, if an electric machine is designed with a 3×3 phase winding (i.e., three parallel three-phase winding strands), it can be permanently connected to the two inverters.

Without limiting the application of embodiments of the present invention, the first axle of a front axle and the second axle of a rear axle of the electric vehicle may correspond. The active parts of the first electric machine (e.g., with 2×3 phase winding) and the at least one second electric machine (e.g., with 3×3 phase winding) may have the same geometry.

Embodiments of the present invention offer the fundamental advantage that the active parts of the electric machines used in the drive system, which includes, for example, the iron laminated core of the stator and the entire rotor (rotor shaft, magnets, and rotor laminated core(s)), can be the same in terms of geometry and/or choice of material. The winding, which is inserted into each of the electric machines used, can also be the same, although it is then wired differently depending on the electric machine. This is therefore advantageous because the mentioned components can all be manufactured on one production line. The high proportion of equal parts leads to a cost reduction not only in production but also in development.

According to further embodiments of the drive system according to the present invention, the first electric machine and the at least one second electric machine may each comprise a multi-phase electric machine having a plurality of parallel winding branches.

According to further embodiments of the drive system according to the invention, the first electric machine may comprise an M×P phase winding and the at least one second electric machine may comprise an N×P phase winding, wherein M+1=N. In one exemplary scenario, M=2 may be such that the first electric machine may be embodied with a 2×3 phase winding and the at least one second electric machine may be embodied with a 3×3 phase winding. In alternative embodiments, the first electric machine and the at least one second electric machine can both have the same winding system.

According to further embodiments of the drive system according to the invention, the first electric machine may be coupled to the first axle via a differential transmission. In this case, the first axle is configured as a central drive with an electric machine.

According to further embodiments of the drive system according to the invention, the second electric machine may be coupled to the second axle via a differential transmission. According to this embodiment, the second axle may also be configured as a central drive with an electric machine.

According to further embodiments of the drive system according to the invention, two separate second electric machines may be provided on the second axle, each of which provides a single wheel drive. For example, the drive system according to one such embodiment may comprise a first electric machine having 2×3 phase winding with two parallel strands as a central drive and two separate second electric machines each having a 3×3 phase winding with three parallel strands.

According to further embodiments of the drive system according to the invention, a transmission can be arranged between each of the two second electric machines and the corresponding wheel. In alternative embodiments of the drive system according to the present invention, each of the second electric machines may provide a direct drive.

According to further embodiments of the drive system according to the invention, the latter may further comprise a control unit, which is configured i) to connect the further inverter to the first electric machine during longitudinal travel, and ii) to connect the further inverter to one of the two separate second electric machines during cornering. In other words, the further inverter can be connected to each of the electric machines of the powertrain according to embodiments of the invention. As mentioned previously, the control unit may also be brought into a switching state in which the further inverter is not coupled to any of the electric machines of the powertrain according to embodiments of the invention, and then in preferred embodiments is then also deactivated.

According to further embodiments of the drive system according to the invention, all inverters of the drive system may be configured for the same voltage and current levels. Accordingly, all of the inverters of the drive system may be operated at the same voltage and current levels.

The aforementioned features and the features yet to be explained in the following embodiments can be used not only in the respectively specified combination, but also in other combinations or on their own, without leaving the scope of the present invention.

Additional advantages and configurations of the invention emerge from the following description of the example embodiments and the enclosed drawings.

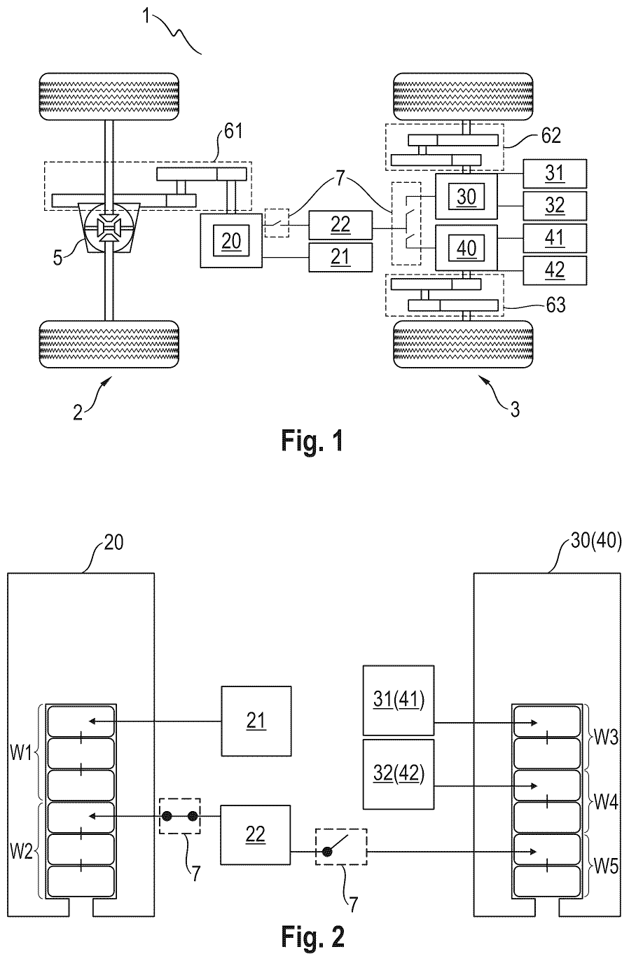

FIG. 1 shows an example embodiment of the powertrain 1 according to the invention for an electric vehicle. This comprises a first electric machine 20, which is coupled to a first axle 2 of the electric vehicle, and two separate second electric machines 30, 40, which are coupled to a second axle 3 of the electric vehicle. In the example embodiment shown, the second axle 3 is embodied as a single wheel drive with the two electric machines 30, 40. The first axle 2 may correspond to a front axle and the second axle 3 may correspond to a rear axle. Accordingly, but without limitation of the general case, the following is therefore referred to as a front and a rear axle.

The first electric machine 20 is permanently connected to a front inverter 21, and each of the two second electric machines 30, 40 is permanently connected to a first rear inverter 31 and a second rear inverter 32 or to a third rear inverter 41 and a fourth rear inverter 42. The front inverter 21, and rear inverter 31, 32, 41, 42 may be considered dedicated inverters because they are fixedly associated with the respective electric machines 20, 30, 40. As can be derived from the number of fixed and potentially switchable inverters, the front electric machine 20 is a 2×3 phase machine and the two rear electric machines 30, 40 are each 3×3 phase machines.

The powertrain 1 further comprises a further inverter 22, which can be optionally connected to the front electric machine 20 or to one of the two rear electric machines 30, 40. To this end, a switching device is provided by means of which the further inverter 22 can be coupled to one of the three electric machines 20, 30, 40 depending on the driving dynamics.

The drive train 1 further comprises a differential 5, which is arranged between a first transmission 61 and the front axle 2. Similarly, each of the two single wheel drives implemented by way of the two rear electric machines 30, 40 has a corresponding transmission 62, 63.

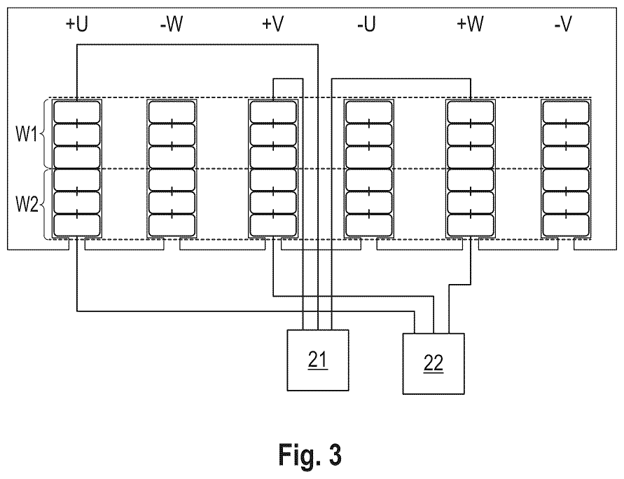

FIG. 2 illustrates the interplay of the inverters with the electric machines within the exemplary powertrain 1 shown in FIG. 1. Each of the inverters 21, 31 (41), 32 (42) is arranged in three phases and only the electrical connection to one phase is illustrated. On the left-hand side of FIG. 2, the front electric machine 20 is sketched, which comprises a first group W1 and a second group W2 of parallel winding strands and is therefore configured as a 2×3 phase machine. On the right-hand side of FIG. 2, only the first rear electric machine 30 is sketched, which in turn comprises a third group W3, a fourth group W4, and a fifth group W5 of parallel winding strands and is therefore configured as a 3×3 phase machine. The second rear electric machine 40 is constructed in the same manner. Thus, the reference characters relating to the second rear electric machine 40 are indicated in parentheses. In each winding W1-W5, the conductors are represented by rectangles, which are connected to each other in series, indicated by small dashes between them.

An exemplary, highly simplified winding diagram showing electrical contact between the three phases U, V, W of the first and second winding W1, W2 in the first machine 20 and the first inverter 21 and the further inverter 22 is shown in FIG. 3 (number of holes q=1).

The first inverter 21 is fixedly/permanently connected to the front electric machine 20. The first rear inverter 31 and the second rear inverter 32 are fixedly/permanently connected to the first rear electric machine 30. The further inverter 22 is not fixedly/permanently connected to any of the inverters, but can be dynamically connected to one of the electric machines 20, 30. This is achieved by means of the switching device 7, which comprises, for example, three switch groups (two switch groups are shown in FIG. 2) (see FIG. 1, where one switch symbol represents one switch group).

FIG. 2 illustrates a switching state in which the left-hand switches of switching device 7 are closed, while the right-hand switches of the switching device 7 are open (including the switches which lead to the second rear electric machine 40), such that the further inverter 22 is coupled to the front electric machine 20. Consequently, both groups W1, W2 are powered by parallel winding strands of the front electric machine 20. In the first rear electric machine 30, the third group W3 and the fourth group W4 are powered by parallel winding strands. The fifth group W5 of winding strands, on the other hand, is not powered and the first rear electric machine 30 behaves like a 2×3 phase electric machine.

The powertrain according to an embodiment of the invention can be configured and controlled by means of a control unit accordingly, such that the further inverter 22 is switched to one of the rear electric motors 30, 40 during cornering and to the front electric motor 20 during longitudinal travel. Based on the exemplary powertrain 1 according to the embodiment of the invention shown in FIG. 1, a supply voltage of the battery of U_{DC}=650 V, which is applied to the inverters 21, 22, 31, 32, 41, 42, an effective continuous current of I_{s,rms}=400 A per inverter, and a gear ratio (in the low-speed, reduction transmission) of i=11,926 and the further assumption that no saturation occurs in the magnetic circuit, this results in a torque constantkₘ which indicates the electromagnetic torque Mₑ in newton meters as a function of the effective phase current I_{s,rms} in amperes (kₘ=Mₑ/l_{s,rms}). With the assumption of negligible saturation effects in the magnetic circle, the electromagnetic torque is Mₑ directly proportional to the number of strand turns Nₛ:Mₑ˜Nₛ and thus also to the torque constantkₘ˜Nₛ. Here, the number of winding turns, which is also referred to as the magnetically effective number of turns, is defined as follows:

$${N}_{s} = \frac{2 \cdot p \cdot q \cdot {N}_{c}}{a}$$

with the number of pole pairsp, the number of holesq, the number of turns per coil (as a two-layer winding) N_{c}, and the number of parallel winding branches a. For a purely exemplary machine topology with number of pole pairs p=3, number of holes q=2, number of turns per coil N_{c}=3, a, this results in a=2number of turns per phase of Nₛ=18 for the 2×3 phase machine (e.g., front electric machine 20 in FIGS. 1 and 2) with the number of parallel winding branches. With the assumption of a 3×3 phase machine identical to the winding (e.g., first and second rear electric machines 30, 40) with the number of parallel winding branches of a=3, a continuous winding number of 12 results for these machinesNₛ=. Assuming a torque constant for the 2×3 phase machine (20) with the number of turns

$$18 ( a = 2 ) of {k}_{m , 2 \times 3} = 0.3425 \frac{N m}{A} ,$$

results a torque constant of

$${k}_{m , 3 \times 3} = 0.3425 \frac{N m}{A} \cdot \frac{12}{18} = 0.2283 \frac{N m}{A}$$

from a 3×3 phase machine with a number of turns of 12 (a=3). The general formulaic relationship for the torque on the wheel M_{rad} will be described as follows: M_{rad}=i. kₘ. I_{s,rms,ges}. The following relationships arise for the adjustable configurations of the drive train according to an embodiment of the invention:

Front electric machine 20 (2×3 phase, a=2)
with an inverter 21:

$${k}_{m , 2 \times 3} = 0.3425 \frac{N m}{A} and {I}_{s , rm s , g e s} = 400 A ,$$

with two inverters (inverters 21, 22):

$${k}_{m , 2 \times 3} = 0.3425 \frac{N m}{A} and {I}_{s , rm s , g e s} = 800 A .$$

Rear electric machine 30, 40 (each 3×3 phase a=3)
with two inverters each (inverter 31, 32 or inverter 41, 42):

$${k}_{m , 3 \times 3} = 0.2283 \frac{N m}{A} and {I}_{s , rm s , g e s} = 800 A ,$$

with three inverters each (inverters 22,31,32 or inverters 22,41,42):

$${k}_{m , 3 \times 3} = 0.2283 \frac{N m}{A} and {I}_{s , rm s , g e s} = 1200 A .$$

The following torques are produced by the electric machines 20, 30, 40:

When cornering (left curve):

Front electric machine 20 (2×3 phase)—Central drive front axle, operating on only one inverter (front inverter 21):

$$11 , 926 \cdot 0.3425 \frac{N m}{A} \cdot 400 A = 1633.9 Nm .$$

First rear electric machine 30 (3×3 phase)—Right rear wheel drive, operation with a total of three inverters, namely the first rear inverter 31, the second rear inverter 32, and the further inverter 22:

$$11 , 926 \cdot 0.2283 \frac{N m}{A} \cdot 1200 A = 3267.3 Nm .$$

Second rear electric machine 40 (3×3 phase)—Left rear wheel drive, operating with a total of two inverters, namely the third rear inverter 32 and the fourth rear inverter 42:

$$11 , 926 \cdot 0.2283 \frac{N m}{A} \cdot 1200 A = 2178.2 Nm .$$

From this it can be seen that torque vectoring can produce a torque differential of up to 1089.1 Nm between torque inside and outside the bend.

### During Longitudinal Travel:

Front electric machine 20 (2×3 phase)—Central drive front axle, operating with two inverters, namely front inverter 21 and further inverter 22:

$$11 , 926 \cdot 0.3425 \frac{N m}{A} \cdot 800 A = 3267.8 Nm .$$

First rear electric machine 30 (3×3 phase)—Left rear wheel drive, operating with a total of two inverters, namely first rear inverter 31 and second rear inverter 32:

$$11 , 926 \cdot 0.2283 \frac{N m}{A} \cdot 800 A = 2178.2 Nm .$$

Second rear electric machine 40 (3×3 phase)—Left rear wheel drive, operating with a total of two inverters, namely the third rear inverter 41 and the second rear inverter 42:

$$11 , 926 \cdot 0.2283 \frac{N m}{A} \cdot 800 A = 2178.2 Nm .$$

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A drive system for an electric vehicle, comprising:
and,
wherein the first electric machine is permanently connected to a first number of first inverters, and the at least one second electric machine is permanently connected to a second number of second inverters, and
wherein a further inverter is provided, which is optionally connectable to the first electric machine or to the at least one second electric machine via a switching device.

2. The drive system according to claim 1,
comprising a plurality of parallel winding branches.

3. The drive system according to claim 2,
further comprises an M×P phase winding and the at least one second electric machine further comprises an N×P phase winding, wherein M+1=N.

4. The drive system according to claim 1,

5. The drive system according to claim 1,
at least one second electric machine is coupled to the second axle via a differential transmission.

6. The drive system according to claim 1,
of the at least one second electric machine are provided on the second axle, each of which provides a single wheel drive.

7. The drive system according to claim 6,
and a corresponding wheel.

8. The drive system according to claim 6,

9. The drive system according to claim 6, further comprising:
connect the further inverter to the first electric machine during longitudinal travel, and
connect the further inverter to one of the two separate second electric machines during cornering.

10. The drive system according to claim 1,
a same voltage level and a same current level.
